(19) United States
(12) Patent Application Publication
(10) Pub. No.: US 2021/0073266 A1
(43) Pub. Date: Mar. 11, 2021

(54) RECORDING MEDIUM RECORDED WITH SEARCH PROGRAM, SEARCH METHOD, AND TERMINAL APPARATUS

(71) Applicant: MERCARI, INC., Tokyo (JP)

(72) Inventor: Hirofumi NAKAGAWA, Tokyo (JP)

(21) Appl. No.: 17/008,423

(22) Filed: Aug. 31, 2020

(30) Foreign Application Priority Data
Sep. 5, 2019 (JP) 2019-162269

(51) Int. Cl. G06F 16/532; G06K 9/62; G06F 16/538; G06Q 30/06

(52) U.S. Cl. CPC G06F 16/532; G06K 9/6201; G06Q 30/0643; G06Q 30/0625; G06F 16/538

(57) ABSTRACT

A non-transitory computer-readable recording medium recorded with a search program executable by a processor of a terminal apparatus, the search program causing the processor to perform operations including issuing a capture start instruction to start to capture a display image displayed on a screen in response to a user operation, acquiring the captured display image, and issuing a search request including, as a search query, an image of an object extracted from the acquired display image, and displaying a search result on the screen.

### CROSS-REFERENCE TO RELATED APPLICATION

The present application is based on and claims priority under 35 U. S. C. § 119 to Japanese Patent Application No. 2019-162269, filed on Sep. 5, 2019, the content of which is incorporated herein by reference in its entirety.

### BACKGROUND OF THE INVENTION

### Field of the Invention

The present invention relates to a recording medium recorded with a search program, a search method, and a terminal apparatus.

### Description of the Related Art

It is known that users operate applications to use services with which users can buy and sell products on the Internet. In general, such an application has a search function allowing the user to search a desired product in the service. Such a search function may include a search function using an image as a search query. With such a search function, when the user finds an item of interest (for example, sneakers worn by a person in an image posted to social media or social networking service (hereinafter referred to as (SNS)) while the user is viewing a screen of a currently executed application (for example, an SNS application), the user can search a product similar to the item of interest by capturing an image (for example, taking a screenshot) as described in, for example, Japanese Patent No. 6524276.

### SUMMARY OF THE INVENTION

However, with such a search function, the user needs to capture an image each time the user finds an item of interest while viewing the screen. Furthermore, the user needs to launch an application for using the above service and send a search request with the captured image as a search query to the site providing the above service. As described above, the above search function using an image as a search query has a problem in poor operability for the users. The present invention has been made in view of the above problems, and it is an object of the present invention to improve the operability of the search function using an image as search query. According to an embodiment of the present invention, for example, a non-transitory computer-readable recording medium is recorded with a search program executable by a processor of a terminal apparatus, and the search program causes the processor to perform operations including issuing a capture start instruction to start to capture a display image displayed on a screen in response to a user operation, acquiring the captured display image, and issuing a search request including, as a search query, an image of an object extracted from the acquired display image, and displaying a search result on the screen.

According to the present invention, the operability of the search function using an image as a search query can be improved.

### BRIEF DESCRIPTION OF THE DRAWINGS

FIG. 1 is a drawing illustrating an example of a system configuration of a search system;

FIG. 2 is a drawing illustrating an example of a hardware configuration of a server apparatus;

FIG. 3 is a drawing illustrating an example of a hardware configuration of a terminal apparatus;

FIG. 4 is a drawing for explaining an operation of software in the terminal apparatus;

FIGS. 5A and 5B illustrate a concrete example (Case 1) of a display screen and a process content performed by the terminal apparatus;

FIGS. 6A and 6B illustrate a concrete example (Case 2) of a display screen and a process content performed by the terminal apparatus;

FIGS. 7A and 7B illustrate a concrete example (Case 3) of a display screen and a process content performed by the terminal apparatus;

FIGS. 8A and 8B illustrate a concrete example (Case 4) of a display screen and a process content performed by the terminal apparatus;

FIGS. 9A and 9B illustrate a concrete example (Case 5) of a display screen and a process content performed by the terminal apparatus;

FIGS. 10A and 10B illustrate a concrete example (Case 6) of a display screen and a process content performed by the terminal apparatus;

FIGS. 11A and 11B illustrate a concrete example (Case 7) of a display screen and a process content performed by the terminal apparatus;

FIG. 12 is a drawing illustrating an example of a functional configuration of a search application;

FIG. 13 is a flowchart illustrating a flow of a search process performed by the terminal apparatus.

FIG. 14 is a drawing illustrating a display example of a message including a search result;

FIGS. 15A and 15B illustrate a display example of a search result (Display Example 1); and

FIG. 16 is a display example of a search result (Display Example 2).

### DESCRIPTION OF THE EMBODIMENT

Hereinafter, the details of embodiments are explained below. In the description of the specification and drawings according to embodiments, constituent elements having substantially the same functional configurations are denoted with the same reference numerals, and redundant description thereabout is omitted.

### First Embodiment

System Configuration of Search System

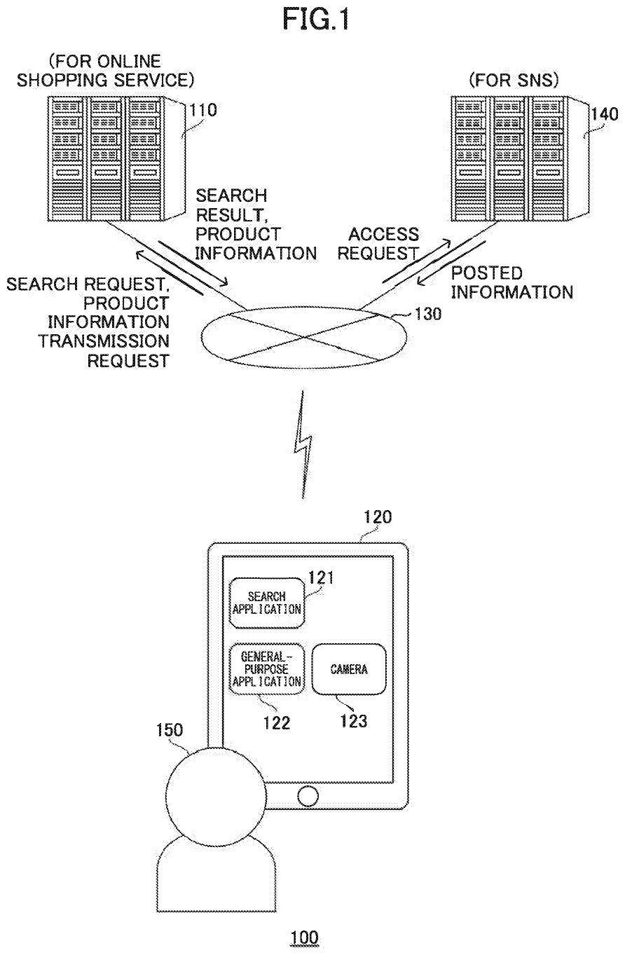

First, the system configuration of the search system that searches for images is explained. FIG. 1 is a drawing illustrating an example of the system configuration of the search system.

As illustrated in FIG. 1, the search system 100 includes a server apparatus 110, a server apparatus 140, and a terminal apparatus 120 used by a user 150. The terminal apparatus 120 is communicably connected to the server apparatus 110 and the server apparatus 140 via a network 130.

The server apparatus 110 is an apparatus that performs an image search based on a search query in the search system 100. For example, the server apparatus 110 is an apparatus that provides an online shopping service for buying and selling products on the Internet (e.g., a consumer-to-consumer online shopping service allowing the user 150 to buy and sell items with other users).

In the present embodiment, when the server apparatus 110 receives a search request from the user 150, the server apparatus 110 searches the registered products for a product similar to the article desired by the user 150 and transmits a search result to the user 150. In addition, when the server apparatus 110 receives a product information transmission request from the user 150, the server apparatus 110 transmits, to the user 150, the detailed information (product information) about the product transmitted as a search result.

The server apparatus 140 is an apparatus that provides an image serving as a search query in the search system 100. For example, the server apparatus 140 is an apparatus that provides information (information including images) on the Internet browsed by the user 150 (specifically, an apparatus that provides an SNS (Social Networking Service) on the Internet).

In the present embodiment, the server apparatus 140 is explained as an apparatus that provides an SNS. When the server apparatus 140 receives an access request from the user 150, the server apparatus 140 transmits, to the user 150, posted information posted by another user.

The terminal apparatus 120 is an apparatus connecting to the network 130 and used by the user 150 who receives various services from the server apparatus 110 and the server apparatus 140. A search application (search program) that searches for images is installed in the terminal apparatus 120. Note that the search application installed in the terminal apparatus 120 includes any application that searches images. However, hereinafter, as an example, a search application operated by the user 150 to use the online shopping service provided by the server apparatus 110 is explained. The search application is started by tapping an icon 121 displayed on the display screen of the terminal apparatus 120.

The search application has a “search function”. Specifically, the search application transmits a search request including an image of the article desired by the user 150 as a search query to a site that provides the online shopping service for buying and selling products on the Internet. The search application receives the search result transmitted from the server apparatus 110 in response to the search request and displays the search result on the display screen of the terminal apparatus 120.

Also, the search application has an “information acquisition function”. Specifically, the search application transmits a product information transmission request for requesting the server apparatus 110 to transmit detailed information (product information) about the search result, receives the product information transmitted from the server apparatus 110 in response to the product information transmission request, and displays the product information on the display screen of the terminal apparatus 120.

The search application may further include a “purchase function” for purchasing the product of which the product information is displayed.

A general-purpose application (SNS application) operated by the user 150 to use the SNS provided by the server apparatus 140 is installed in the terminal apparatus 120. The general-purpose application is started by tapping an icon 122 displayed on the display screen of the terminal apparatus 120.

The general-purpose application transmits an access request to the server apparatus 140, receives posted information posted by another user and transmitted from the server apparatus 140 in response to the access request, and displays the posted information on the display screen of the terminal apparatus 120.

In addition, a camera control application that controls the built-in image-capturing device (not illustrated in FIG. 1) is installed in the terminal apparatus 120. The camera control application is started when an icon 123 displayed on the display screen of the terminal apparatus 120 is tapped (or when a start instruction is transmitted from the search application).

The camera control application acquires the captured image by controlling the built-in image-capturing device and displays the captured image on the display screen of the terminal apparatus 120.

According to the above configuration, the search application automatically extracts an image serving as a search query from the display image displayed on the terminal apparatus 120 while the general-purpose application or the camera control application is being executed, and transmits the search request to the server apparatus 110.

Therefore, by simply browsing images provided by the server apparatus 140 (for example, images on the SNS) or starting to take a picture of a person, the user 150 can acquire, from the server apparatus 110, for example, a search result of products similar to an article posted to the SNS or similar to an article of the person. As a result, for example, the user 150 can immediately purchase, from a site that provides an online shopping service, the sneakers worn by the person in the image posted to the SNS that the user 150 is browsing.

Hardware Configuration of Server Apparatus

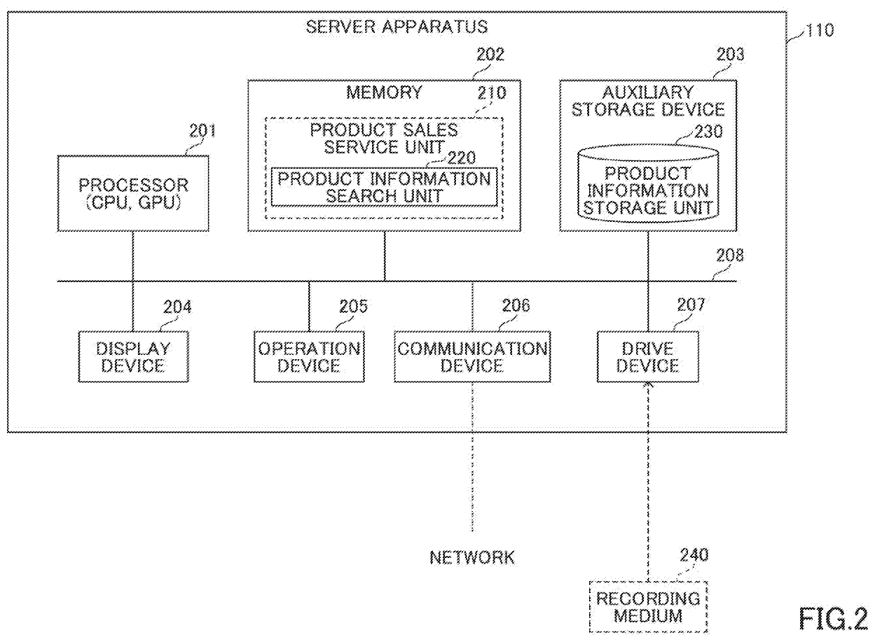

Subsequently, the hardware configuration of the server apparatus 110 is explained. FIG. 2 is a drawing illustrating an example of the hardware configuration of the server apparatus.

As illustrated in FIG. 2, the server apparatus 110 includes a processor 201, a memory 202, an auxiliary storage device 203, a display device 204, an operation device 205, a communication device 206, and a drive device 207. The pieces of hardware in the server apparatus 110 are connected to each other via a bus 208.

The processor 201 has various arithmetic devices such as a CPU (Central Processing Unit) and a GPU (Graphics Processing Unit). The processor 201 reads various programs onto the memory 202 and executes the various programs.

The memory 202 has main storage devices such as a ROM (Read Only Memory) and a RAM (Random Access Memory). The processor 201 and the memory 202 constitute what is termed as a computer, and the processor 201 executes various programs loaded to the memory 202, so that the computer achieves various functions.

The example of FIG. 2 illustrates a case where the processor 201 executes a product sales program loaded to the memory 202, and the computer functions as an online shopping service unit 210.

It should be noted that the online shopping service unit 210 according to the first embodiment includes a product information search unit 220. In response to a search request from the user 150, the product information search unit 220 refers to a product information storage unit 230 implemented in the auxiliary storage device 203, and searches for products similar to the article desired by the user 150. The product information search unit 220 extracts a product with a high degree of similarity from the searched products, and transmits the information identifying the extracted product to the user 150 as the search result.

In addition, when the user 150 transmits, to the server apparatus 110, a product information transmission request for requesting detailed information (product information) about the search result in response to the transmission of the search result, the product information search unit 220 transmits product information to the user 150.

The auxiliary storage device 203 stores various kinds of programs and various kinds of information used by the various kinds of programs executed by the processor 201. The product information storage unit 230 that stores information about the registered products as described above is implemented in the auxiliary storage device 203.

The display device 204 is a display device that displays the internal state of the server apparatus 110. The operation device 205 is an input device used by the administrator of the server apparatus 110 to enter various kinds of instructions to the server apparatus 110. The communication device 206 is a communication device that is connected to the network 130 to communicate with the terminal apparatus 120.

The drive device 207 is a device for reading and writing a recording medium 240. The recording medium 240 referred to herein includes a medium such as a CD-ROM, a flexible disk, a magneto-optical disk, and the like, which records information optically, electrically, or magnetically. Further, the recording medium 240 may include semiconductor memory or the like that electrically records information, such as ROM or flash memory.

Various kinds of programs are installed in the auxiliary storage device 203 as follows. For example, the distributed recording medium 240 is set in the drive device 207, and various kinds of programs recorded on the recording medium 240 are read by the drive device 207 and installed to the auxiliary storage device 203. Alternatively, various kinds of programs may be downloaded via the network 130 and installed in the auxiliary storage device 203.

Although the hardware configuration of the server apparatus 140 is not illustrated, the hardware configuration of the server apparatus 140 is generally similar to the hardware configuration of the server apparatus 110 (with a difference in various kinds of programs loaded to the memory 202 and various kinds of information stored in the auxiliary storage device 203). Therefore, the description about the hardware configuration of the server apparatus 140 is omitted here.

Hardware Configuration of Terminal Apparatus

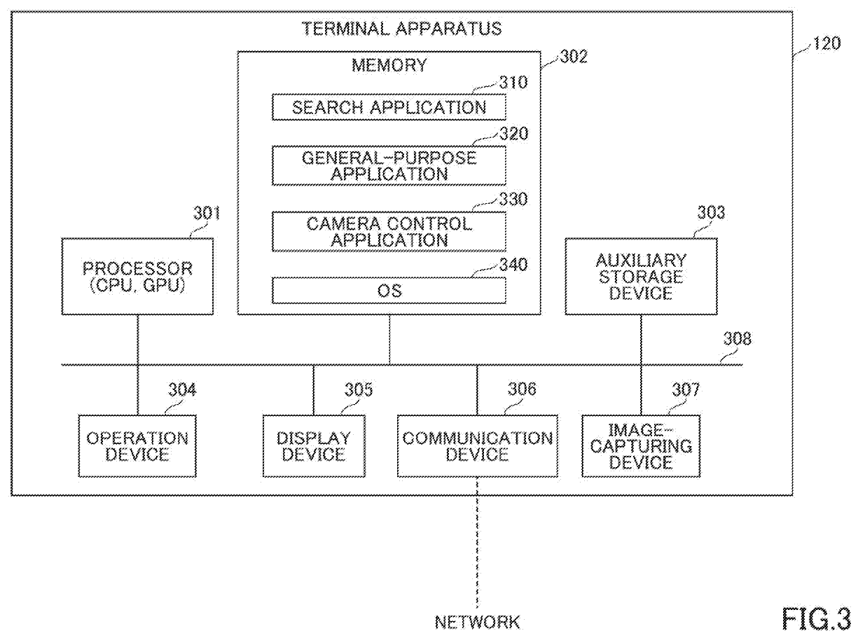

Subsequently, the hardware configuration of the terminal apparatus 120 is explained. FIG. 3 is a drawing illustrating an example of the hardware configuration of the terminal apparatus.

As illustrated in FIG. 3, the terminal apparatus 120 includes a processor 301, a memory 302, an auxiliary storage device 303, an operation device 304, a display device 305, a communication device 306, and an image-capturing device 307. The pieces of hardware in the terminal apparatus 120 are connected to each other via the bus 308.

As illustrated in FIG. 3, the pieces of hardware of the terminal apparatus 120 are also generally similar to the pieces of hardware of the server apparatus 110 illustrated in FIG. 2. Accordingly, the differences from FIG. 2 are mainly hereinafter explained.

As illustrated in FIG. 3, various kinds of programs (various kinds of software) executed by the processor 301 of the terminal apparatus 120 on an OS (Operating System) 340 include:
a search application 310;
a general-purpose application 320; and
a camera control application 330.

As illustrated in FIG. 3, the terminal apparatus 120 includes the image-capturing device 307. The image-capturing device 307 captures images of a person at a predetermined frame cycle.

Operation of Software in Terminal Apparatus

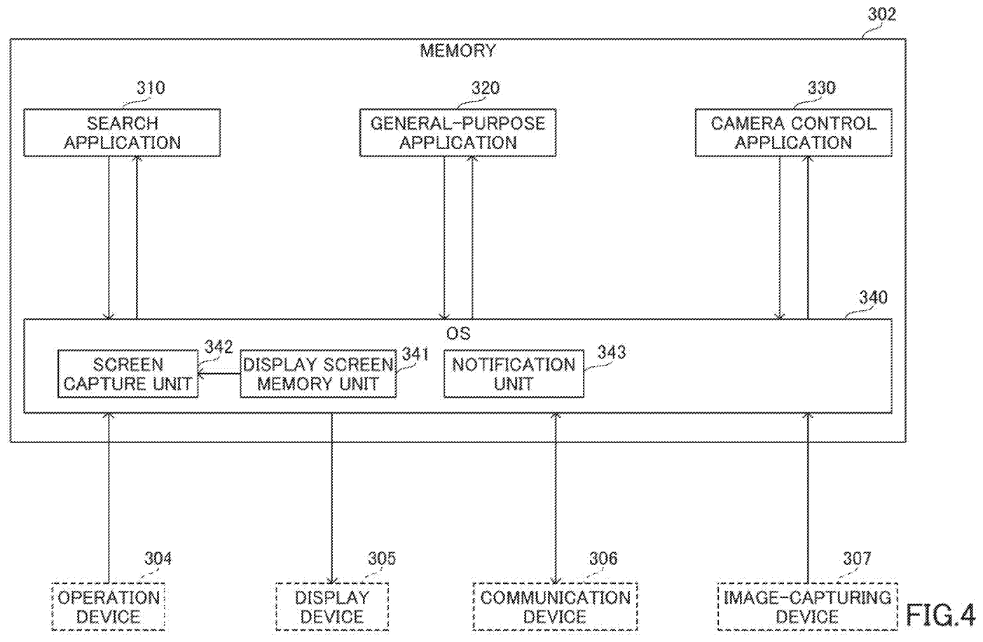

Subsequently, the operation of various kinds of software that the processor 301 loads to the memory 302 and executes in the terminal apparatus 120 is explained. FIG. 4 is a drawing for explaining the operation of the software in the terminal apparatus 120.

As illustrated in FIG. 4, the OS 340 includes a display screen memory unit 341 to store a display image (i.e., a display image generated by various kinds of software) to be displayed on the display screen of the terminal apparatus 120, and transmits the display image to the display device 305.

In addition, the OS 340 has a screen capture unit 342 to capture the display image stored in the display screen memory unit 341. Further, the OS 340 has a notification unit to generate messages based on instructions from various kinds of software (i.e., the search application 310 according to the first embodiment), and transmit the messages to the display device 305. As a result, the user 150 is notified of the messages containing the search result.

For example, the search application 310 is executed by the processor 201 to perform, as initial operations, operations including:
transmitting a capture start instruction or a capture stop instruction to the screen capture unit 342;
acquiring and processing a display image captured by the screen capture unit 342;
generating a display image (e.g., a selection screen image and a product information display image, explained later) to be displayed on the display screen of the terminal apparatus 120, and transmitting the display image to the display device 305;
transmitting various kinds of requests (i.e., a search request and a product information transmission request) to the server apparatus 110 via the communication device 306, and acquiring and processing various kinds of information (e.g., a search result and product information), which are transmitted from the server apparatus 110 in response to the various kinds of requests and which are received via the communication device 306; and
transmitting a start instruction to the camera control application 330.

For example, the general-purpose application 320 is executed by the processor 201 to perform, as initial operations, operations including:
transmitting an access request to the server apparatus 140 via the communication device 306, and receiving posted information posted by another user via the communication device 306; and
generating a display image (i.e., an SNS display image to be displayed later) to be displayed on the display screen of the terminal apparatus 120 on the basis of the received posted information, and transmitting the display image to the display device 305.

For example, the camera control application 330 is executed by the processor 201 to perform, as initial operations, operations including:
acquiring a captured image captured by the image-capturing device 307; and
generating a display image (i.e., a camera display image to be explained later) to be displayed on the display screen of the terminal apparatus 120 on the basis of the acquired captured image, and transmitting the display image to the display device 305.

Explanation about Processing Content Performed on Terminal Apparatus

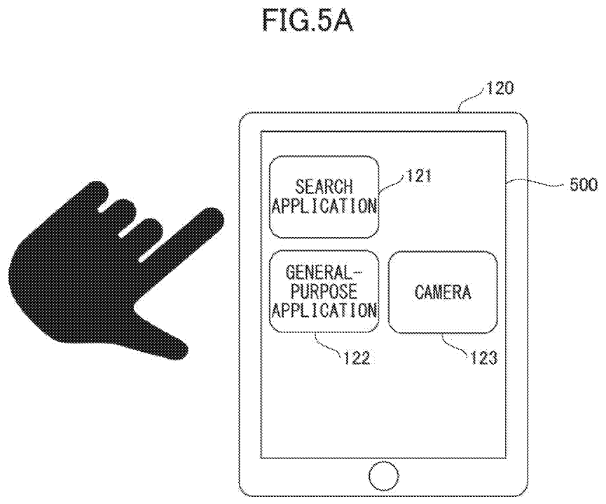

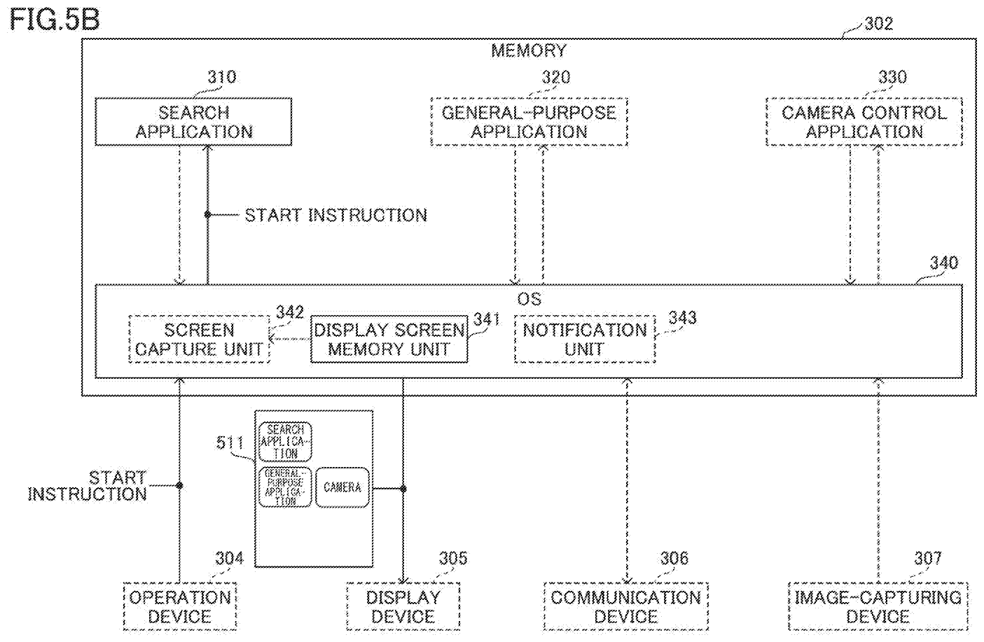

Subsequently, the details of the process content processed by the terminal apparatus 120 in operations of various kinds of software are explained with reference to concrete examples. FIGS. 5A and 5B to FIGS. 11A and 11B illustrate Cases 1 to 7, respectively, which are concrete examples of the process contents performed by the terminal apparatus 120.

Among FIGS. 5A and 5B to FIGS. 11A and 11B, FIGS. 5A and 5B illustrate a concrete example (Case 1) of the process content performed by the terminal apparatus 120 when the user 150 starts the search application 310.

As illustrated in FIG. 5B, a home screen display image 511 generated by the OS 340 is stored in the display screen memory unit 341 and transmitted to the display device 305. As a result, as illustrated in FIG. 5A, the home screen display image 511 is displayed on a display screen 500 of the terminal apparatus 120.

As illustrated in FIG. 5A, the search application 310 is started when a predetermined user operation is performed on the display screen 500 on which the home screen display image 511 is displayed.

Specifically, when the user 150 taps the icon 121 on the display screen 500 on which the home screen display image 511 is displayed, as illustrated in FIG. 5B, the operation device 304 transmits a start instruction to the search application 310 via the OS 340. Accordingly, the search application 310 is started.

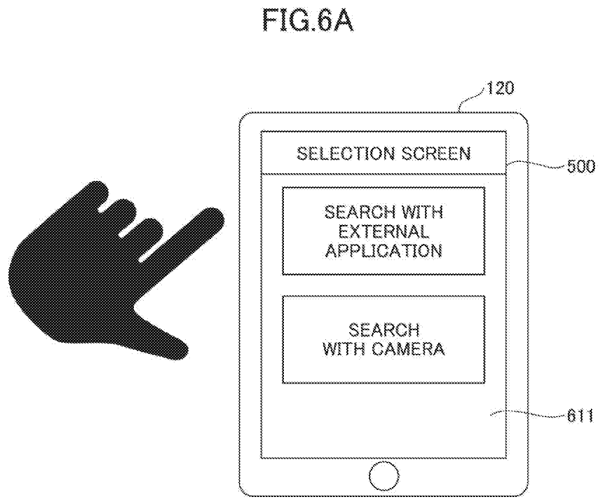

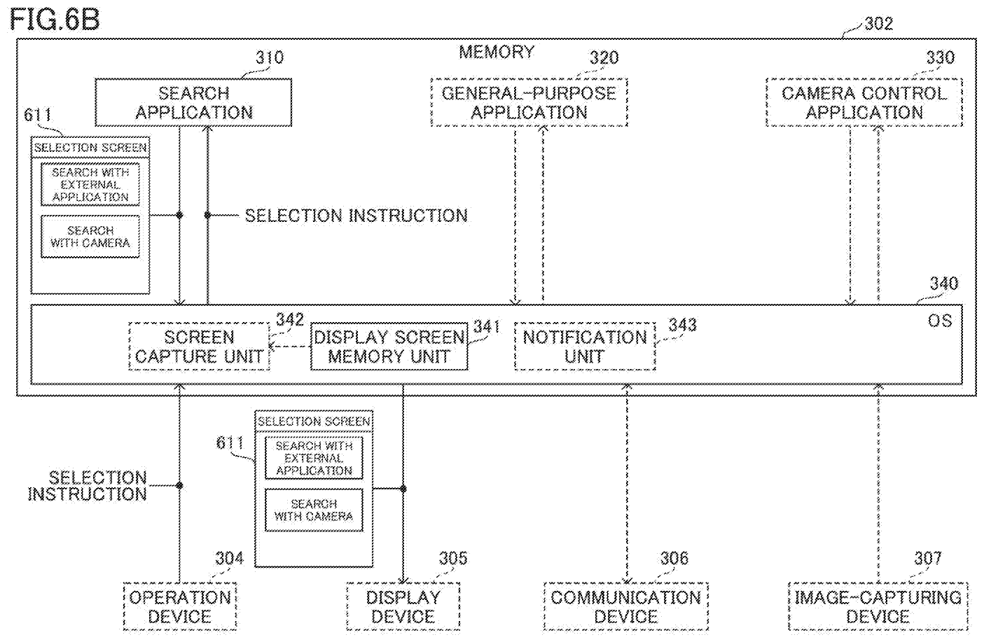

When the search application 310 is started, as illustrated in FIG. 6B, the search application 310 generates a selection screen image 611 for selecting a search method, and transmits the selection screen image 611 to the display screen memory unit 341. The selection screen image 611 in the display screen memory unit 341 is transmitted to the display device 305. As a result, as illustrated in FIG. 6A, the selection screen image 611 is displayed on the display screen 500 of the terminal apparatus 120.

When a predetermined user operation is performed on the display screen 500 on which the selection screen image 611 is displayed, the selection screen image 611 disappears.

Specifically, when the user 150 taps “SEARCH WITH EXTERNAL APPLICATION”, as illustrated in FIG. 6B, the operation device 304 transmits a selection instruction of a search method to the search application 310 via the OS 340. Accordingly the search application 310 stops transmission of the selection screen image 611 to the display screen memory unit 341. As a result, the selection screen image 611 disappears, and the display screen 500 of the terminal apparatus 120 displays the home screen display image 511 generated by the OS 340 again.

While the selection screen image 611 is displayed on the display screen 500, the search application 310 does not transmit a capture start instruction to the screen capture unit 342. In other words, while the selection screen image 611 is displayed on the display screen 500, the search application 310 performs control so that the search result is not displayed on the display screen 500.

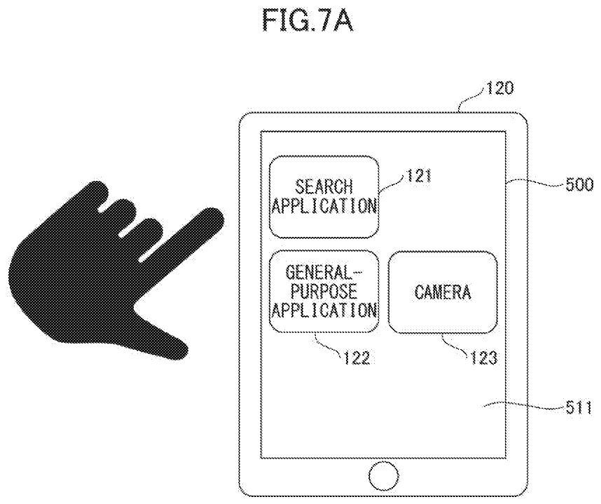

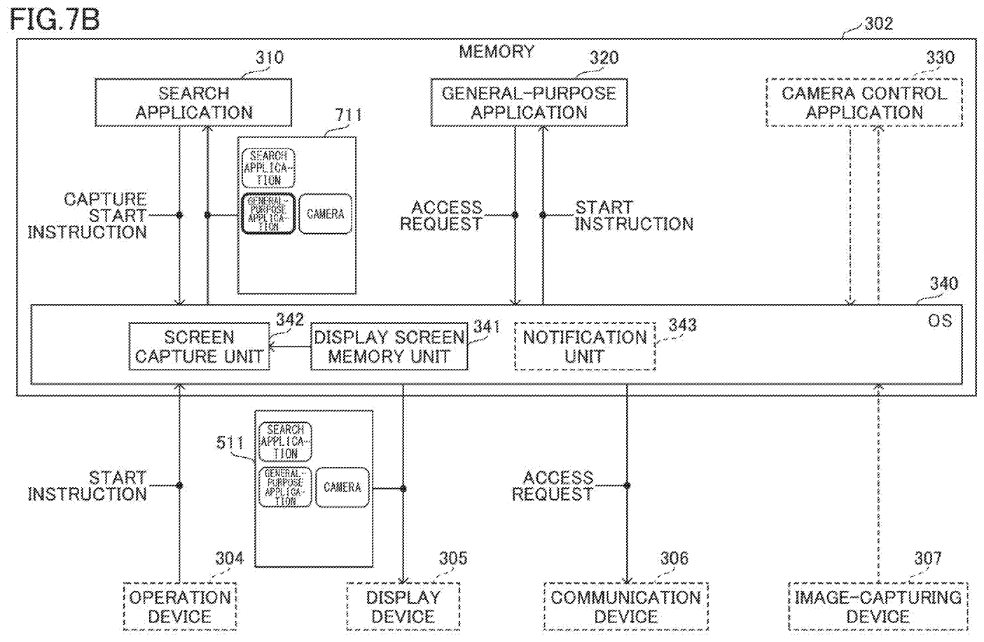

FIGS. 7A and 7B illustrate a concrete example of the display screen and the process content performed by the terminal apparatus 120 when the selection screen image 611 disappears, and the user 150 starts the general-purpose application 320 while the home screen display image 511 is displayed on the display screen 500 of the terminal apparatus 120.

Since the selection screen image 611 disappears, as illustrated in FIG. 7B, the search application 310 transmits a capture start instruction to the screen capture unit 342. Accordingly, the screen capture unit 342 starts capturing the display image stored in the display screen memory unit 341, and the search application 310 acquires the display image captured by the screen capture unit 342 at a predetermined cycle.

At this point in time, as illustrated in FIG. 7B, the home screen display image 511 is transmitted to the display device 305, and as illustrated in FIG. 7A, the display screen 500 of the terminal apparatus 120 displays the home screen display image 511.

Accordingly, the search application 310 extracts objects from the home screen display image 511. However, the search application 310 extracts an object of which the size is less than a predetermined threshold value.

Here, the reason why the search application 310 extracts an object of which the size is less than the predetermined threshold value is that, if the size were not limited, the entire home screen display image 511 would be extracted as an object. In a case where the entire home screen display image 511 were extracted as an object, the server apparatus 110 would perform search with the entire home screen display image 511 as a search query, and a smartphone (product) displaying the home screen display image 511 would be transmitted as a search result.

In order to avoid such a situation, the search application 310 extracts an object of which the size is less than the predetermined threshold value (for example, 90% of the size of the home screen display image 511). As a result, the search application 310 does not actually transmit a search result based on the home screen display image 511. Therefore, while the home screen display image 511 is displayed on the display screen 500, the search application 310 performs control so that the search result is not displayed on the display screen 500.

Accordingly, as illustrated in FIG. 7A, when a predetermined user operation is performed on the display screen 500 on which the home screen display image 511 is displayed, the terminal apparatus 120 starts the general-purpose application 320.

Specifically, when the user 150 touches the icon 122, as illustrated in FIG. 7B, the operation device 304 transmits a start instruction to the general-purpose application 320 via the OS 340. As a result, the general-purpose application 320 is started.

When the general-purpose application 320 is started, as illustrated in FIG. 7B, the general-purpose application 320 transmits an access request to the server apparatus 140 via the communication device 306.

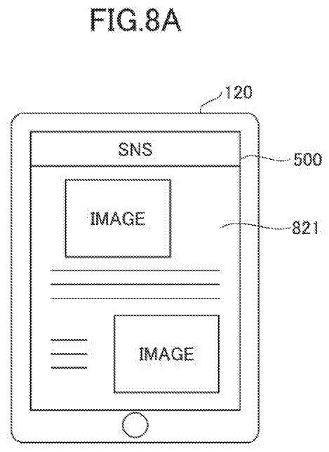

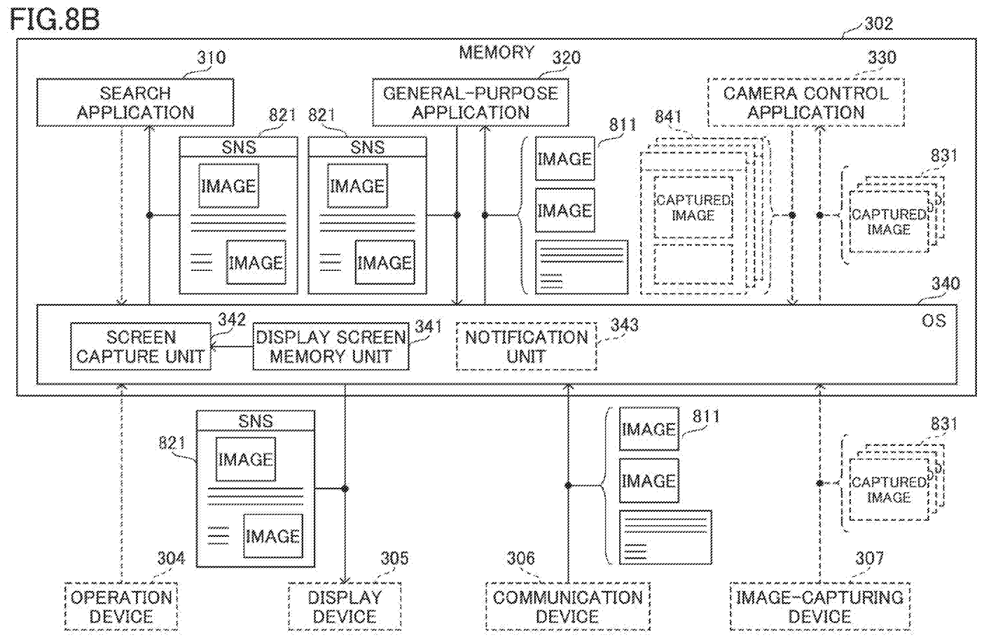

FIGS. 8A and 8B illustrate a concrete example of the display screen and the process content performed by the terminal apparatus 120, when the general-purpose application 320 is started, and an access request is transmitted to the server apparatus 140, in response to which the terminal apparatus 120 receives posted information posted by another user from the server apparatus 140.

As illustrated in FIG. 8B, the general-purpose application 320 receives the posted information 811 posted by another user via the OS 340 with the communication device 306. Accordingly, the general-purpose application 320 generates an SNS display image 821 based on the posted information 811 posted by another user, and transmits the SNS display image 821 to the display screen memory unit 341.

As illustrated in FIG. 8B, the SNS display image 821, which is generated by the general-purpose application 320 and stored in the display screen memory unit 341, is transmitted to the display device 305. As a result, as illustrated in FIG. 8A, the SNS display image 821 is displayed on the display screen 500 of the terminal apparatus 120.

Also, as illustrated in FIG. 8B, the SNS display image 821, which is generated by the general-purpose application 320 and stored in the display screen memory unit 341, is captured by the screen capture unit 342 and acquired by the search application 310.

It should be noted that FIG. 8B also illustrates a concrete example of the display screen and the process content performed by the terminal apparatus in a case where the user 150 taps “SEARCH WITH CAMERA” on the display screen 500 (see FIG. 6A) on which the selection screen image 611 is displayed.

When the “SEARCH WITH CAMERA” is tapped, the selection screen image 611 disappears, and the search application 310 transmits a start instruction to the camera control application 330. Accordingly, the camera control application 330 controls the image-capturing device 307 to cause the image-capturing device 307 to start capturing images.

When the image-capturing device 307 starts capturing images, as illustrated in FIG. 8B, the image-capturing device 307 transmits the captured image 831 to the camera control application 330 via the OS 340. Accordingly, the camera control application 330 generates a camera display image 841 based on the captured image 831 captured by the image-capturing device 307, and transmits the camera display image 841 to the display screen memory unit 341.

It should be noted that the camera display image 841, which is generated by the camera control application 330 and stored in the display screen memory unit 341, is transmitted to the display device 305. As a result, the camera display image 841 is displayed on the display screen 500 of the terminal apparatus 120.

Also, as illustrated in FIG. 8B, the camera display image 841, which is generated by the camera control application 330 and stored in the display screen memory unit 341, is captured by the screen capture unit 342 and is acquired by the search application 310.

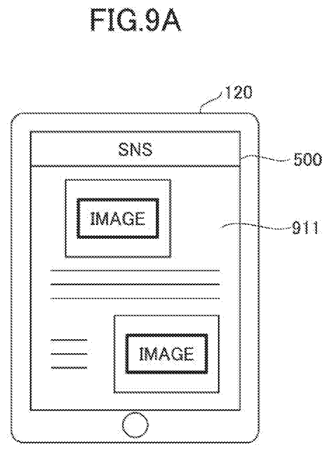

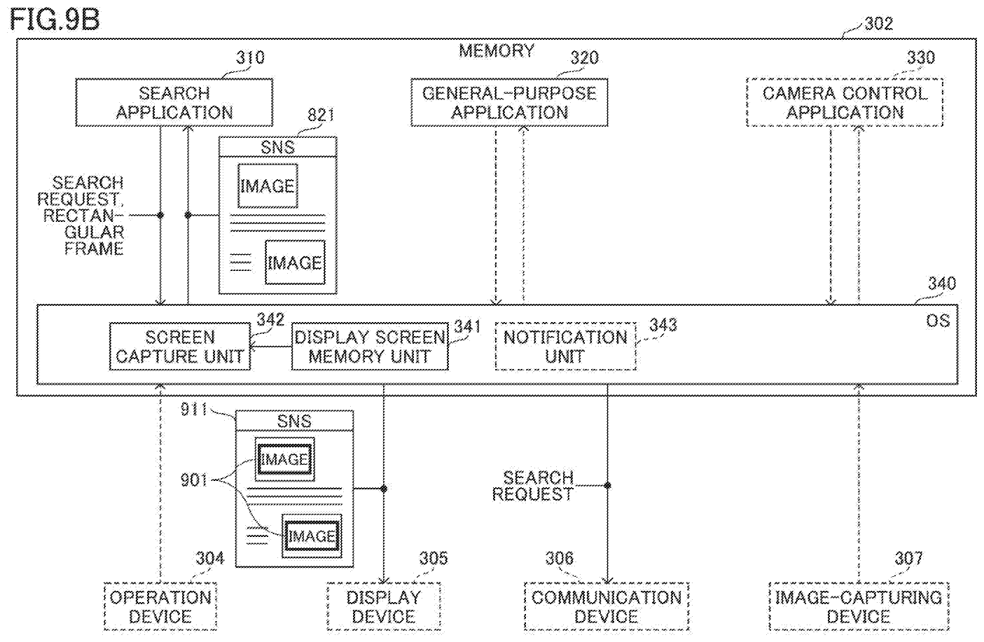

FIGS. 9A and 9B illustrate a concrete example of the display screen and the process content performed by the terminal apparatus 120 when the search application 310 acquires the captured SNS display image 821. As illustrated in FIG. 9B, when the search application 310 acquires the SNS display image 821, the search application 310 extracts an image of an object of which the size is less than the predetermined threshold value (for example, sneakers and the like worn by a person in an image posted to the SNS) included in the SNS display image 821. Also, the search application 310 calculates a feature value of the image of the extracted object.

Also, the search application 310 generates a search request including the calculated feature value (i.e., a search request with (the feature value of) the image as the search query), and transmits the search request to the communication device 306 via the OS 340. Accordingly, the communication device 306 transmits the search request with (the feature value of) the image as the search query to the server apparatus 110.

Also, as illustrated in FIG. 9B, the search application 310 generates a rectangular frame circumscribing the extracted object, and transmits the rectangular frame to the display screen memory unit 341. Accordingly, the SNS display image 911 in which the rectangular frame 901 is superimposed on the SNS display image 821 stored in the display screen memory unit 341 is transmitted to the display device 305. As a result, as illustrated in FIG. 9A, the SNS display image 911 on which the rectangular frame 901 is superimposed is displayed on the display screen 500 of the terminal apparatus 120. However, the display of the rectangular frame 901 is not mandatory. The rectangular frame 901 may not be displayed, and the rectangular frame 901 may be displayed when an instruction is given from the user 150.

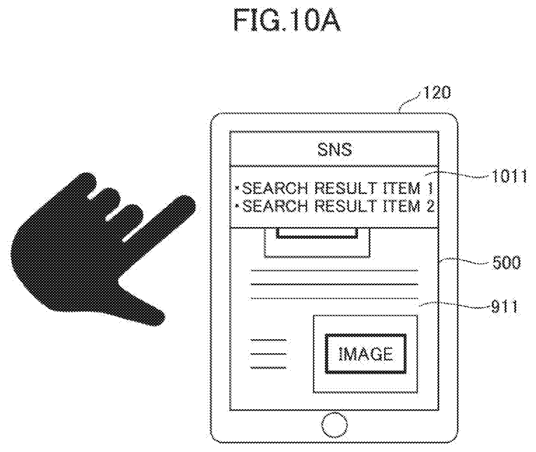

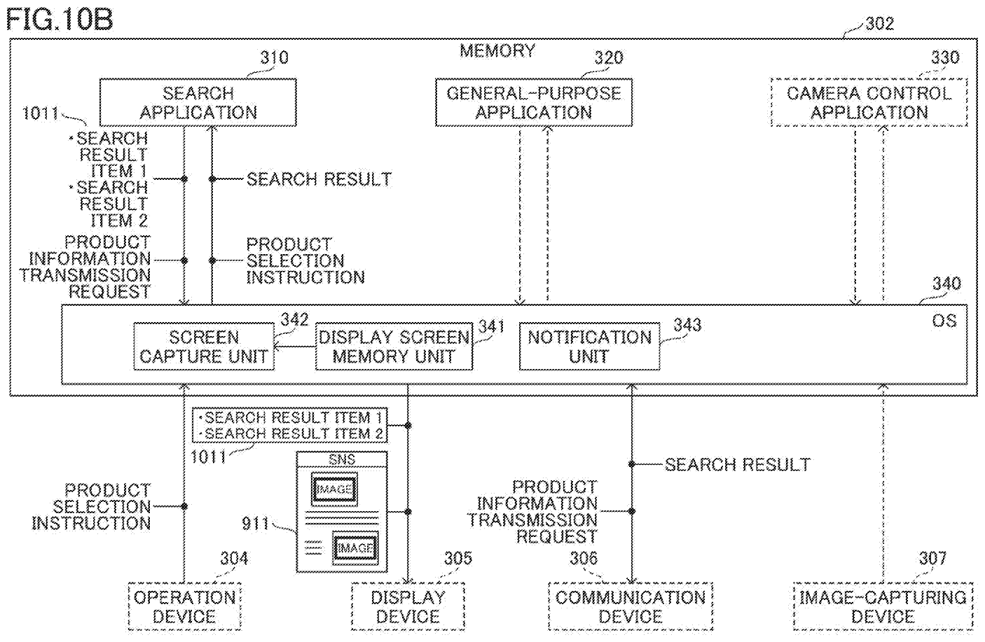

FIGS. 10A and 10B illustrate a concrete example of the display screen and the process content performed by the terminal apparatus 120, when a search request is transmitted to the server apparatus 110, and the server apparatus 110 transmits a search result. As illustrated in FIG. 10B, the search application 310 acquires the search result, which is transmitted from the server apparatus 110 and which is received by the communication device 306, via the OS 340.

Accordingly, the search application 310 transmits a search result 1001 (in the example of FIGS. 10A and 10B, the search result 1001 includes a search result item 1 and a search result item 2) to the notification unit 343, and instructs the notification unit 343 to generate a message notified to the user 150.

The notification unit 343, to which the search result 1001 is transmitted, generates a message 1011 including the search result 1001, and transmits the message 1011 to the display device 305.

Accordingly, as illustrated in FIG. 10A, the message 1011 can be conveyed to the user 150 by displaying, on the display screen 500, the SNS display image 911 on which the rectangular frame 901 is superimposed. In other words, the user 150 can receive a search result by just viewing the SNS.

FIG. 10A illustrates a state in which the user 150 selects the “SEARCH RESULT ITEM 1” while the message 1011 is notified. When the user 150 selects the “SEARCH RESULT ITEM 1”, as illustrated in FIG. 10B, the operation device 304 transmits a product selection instruction to the search application 310 via the OS 340.

When the product selection instruction is transmitted, the search application 310 generates a product information transmission request for requesting transmission of detailed information (product information) about the product identified by the “SEARCH RESULT ITEM 1”. Also, the search application 310 transmits the generated product information transmission request to the server apparatus 110 via the communication device 306.

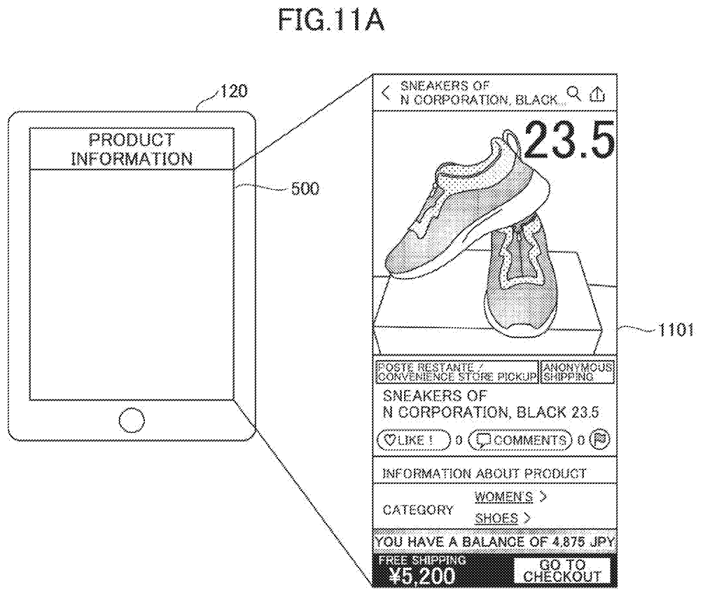

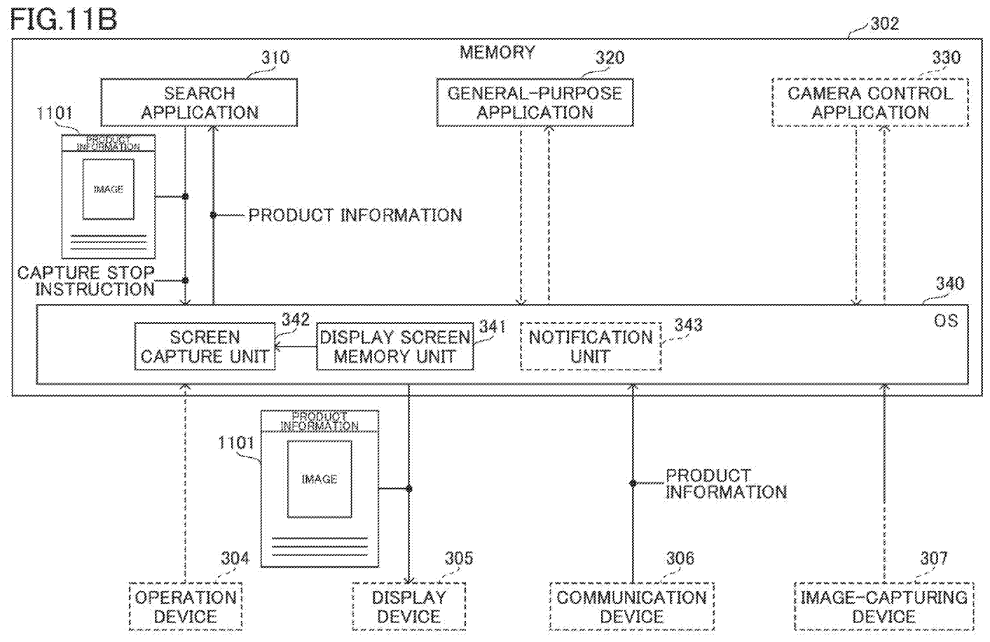

FIGS. 11A and 11B illustrate a concrete example of the display screen and the process content performed by the terminal apparatus 120 when the terminal apparatus 120 receives product information from the server apparatus 110 in response to transmission of a product information transmission request to the server apparatus 110. As illustrated in FIG. 11B, when the search application 310 acquires the product information from the communication device 306 via the OS 340, the search application 310 generates a product information display image 1101, and transmits the product information display image 1101 to the display screen memory unit 341.

The product information display image 1101, which is generated by the search application 310 and stored in the display screen memory unit 341, is transmitted to the display device 305. As a result, as illustrated in FIG. 11A, the product information display image 1101 is displayed on the display screen 500 of the terminal apparatus 120. In this way, with the use of the search application 310, the user 150 can immediately purchase, from a site providing the online shopping service, the sneakers worn by the person in the image posted to the SNS that the user 150 is viewing.

Also, the search application 310 transmits a capture stop instruction to the screen capture unit 342. Accordingly, the screen capture unit 342 stops capturing of the display images stored in the display screen memory unit 341.

It should be noted that the search application 310 stops capturing of the display images with the screen capture unit 342 while the product information display image 1101 is displayed on the display screen 500. Accordingly, the search application 310 can perform control so that the search result is not displayed on the display screen 500 while the product information display image 1101 is displayed on the display screen 500.

If the search application 310 were not configured to stop capturing of the display images with the screen capture unit 342 while the product information display image 1101 is displayed on the display screen 500, the search application 310 would transmit a search request based on an image of an object extracted from the product information display image 1101. As a result, the search result would be displayed on the display screen 500 even while the product information display image 1101 is displayed on the display screen 500. Since the search application 310 stops capturing of the display images with the screen capture unit 342 while the product information display image 1101 is displayed on the display screen 500, the search application 310 can avoid the situation described above.

Thereafter, when the product information display image 1101 disappears, and the SNS display image 821 is displayed on the display screen 500, the search application 310 transmits a capture start instruction to the screen capture unit 342.

Although not explained above, after the search application 310 transmits the capture start instruction to the screen capture unit 342 (FIG. 7B), the user 150 can manually enter a capture stop instruction at any given timing. After the user 150 manually enters the capture stop instruction, the user 150 can manually enter a capture start instruction at any given timing.

Functional Configuration of Search Application

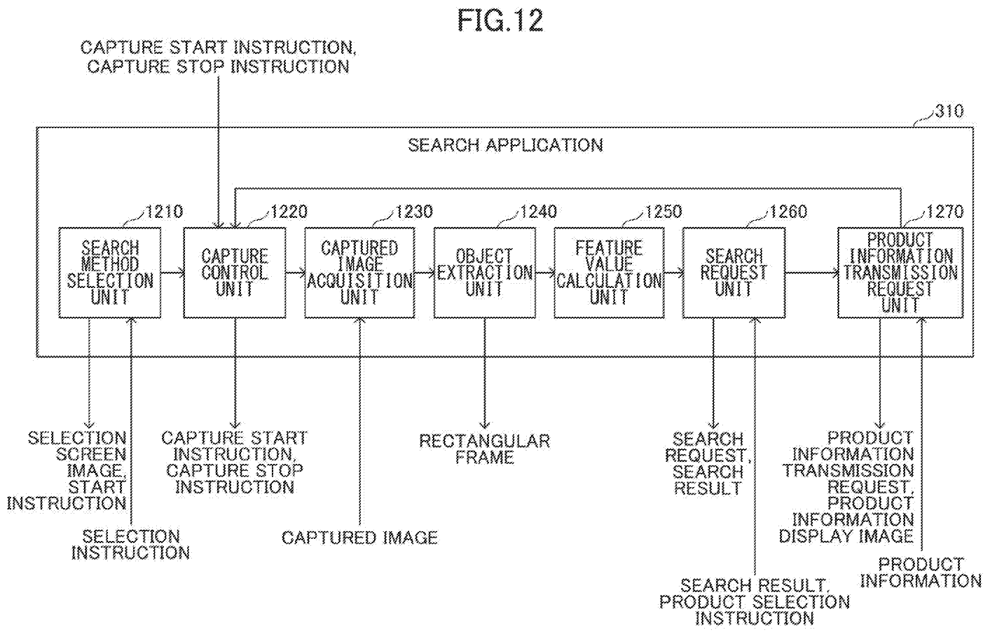

Subsequently, the details of the functional configuration of the search application 310 will be explained. FIG. 12 is a drawing illustrating an example of functional configuration of the search application 310.

As illustrated in FIG. 12, the search application 310 includes a search method selection unit 1210, a capture control unit 1220, and a captured image acquisition unit 1230. In addition, the search application 310 includes an object extraction unit 1240, a feature value calculation unit 1250, a search request unit 1260, and a product information transmission request unit 1270.

The search method selection unit 1210 is an example of a first display unit. The search method selection unit 1210 generates a selection screen image 611, and transmits the selection screen image 611 to the display screen memory unit 341. Also, the search method selection unit 1210 acquires a selection instruction entered by the user 150 in response to displaying of the selection screen image 611.

In a case where the selection instruction is “SEARCH WITH EXTERNAL APPLICATION”, the search method selection unit 1210 stops transmission of the selection screen image 611 to the display screen memory unit 341. In a case where the selection instruction is “SEARCH WITH CAMERA”, the search method selection unit 1210 stops transmission of the selection screen image 611 to the display screen memory unit 341, and transmits a start instruction to the camera control application 330.

Furthermore, the search method selection unit 1210 instructs the capture control unit 1220 to start capturing images.

The capture control unit 1220 is an example of an instruction unit. In a case where the search method selection unit 1210 instructs start of capturing, the capture control unit 1220 transmits a capture start instruction to the screen capture unit 342.

Also, in a case where the product information transmission request unit 1270 instructs the capture control unit 1220 to stop capturing, the capture control unit 1220 transmits a capture stop instruction to the screen capture unit 342. In a case where the product information transmission request unit 1270 instructs the capture control unit 1220 to resume capturing, the capture control unit 1220 transmits a capture start instruction to the screen capture unit 342.

Further, in a case where the user manually enters a capture stop instruction, the capture control unit 1220 transmits a capture stop instruction to the screen capture unit 342. In a case where the user 15 manually enters a capture stop instruction and thereafter manually enters a capture start instruction, the capture control unit 1220 transmits the capture start instruction to the screen capture unit 342.

Also, the capture control unit 1220 also transmits the capture start instruction or the capture stop instruction to the captured image acquisition unit 1230.

The captured image acquisition unit 1230 is an example of an acquisition unit. While the screen capture unit 342 captures display images, the captured image acquisition unit 1230 acquires the display images captured by the screen capture unit 342, at a predetermined cycle. Also, the captured image acquisition unit 1230 transmits the acquired display images to the object extraction unit 1240.

The object extraction unit 1240 extracts an image of an object, of which the size is less than the predetermined threshold value, from the display images transmitted from the captured image acquisition unit 1230, and transmits the image of the object to the feature value calculation unit 1250. Also, the object extraction unit 1240 generates a rectangular frame circumscribing the extracted object, and transmits the rectangular frame to the display screen memory unit 341. The feature value calculation unit 1250 calculates a feature value of the image of the object extracted by the object extraction unit 1240, and transmits the feature value to the search request unit 1260.

The search request unit 1260 is an example of a search unit. The search request unit 1260 generates a search request including the feature value transmitted from the feature value calculation unit 1250 (i.e., a search request with (the feature value of) the image as the search query), and transmits the search request to the communication device 306 via the OS 340. The search request unit 1260 acquires the search result, received by the communication device 306, transmitted from the server apparatus 110 in response to transmission of the search request to the server apparatus 110. The server apparatus 110 searches for an image having a feature value similar to the feature value of the image included in the search request from among the images of the products stored in the product information storage unit 230, and then transmits the search result to the communication device 306.

Also, the search request unit 1260 transmits the acquired search result 1001 to the notification unit 343 of the OS 340. Accordingly, the user 150 is notified of the message 1011 including the search result 1001, and the user 150 selects one of the search result items in the search result 1001. The operation device 304 generates a product selection instruction based on the selection made by the user 150, and the search request unit 1260 receives the product selection instruction from the operation device 304. Further, the search request unit 1260 transmits the received product selection instruction to the product information transmission request unit 1270.

The product information transmission request unit 1270 is an example of a second display unit. When the product information transmission request unit 1270 receives the product selection instruction from the search request unit 1260, the product information transmission request unit 1270 transmits, to the communication device 306, a product information transmission request to request transmission of detailed information about the product (i.e., product information). Also, upon transmission of a product information transmission request to the server apparatus 110, the product information transmission request unit 1270 acquires product information which the communication device 306 receives from the server apparatus 110, and generates the product information display image 1101.

Also, the product information transmission request unit 1270 transmits the generated product information display image 1101 to the display screen memory unit 341. It should be noted that when the product information transmission request unit 1270 transmits the product information display image 1101 to the display screen memory unit 341, the product information transmission request unit 1270 instructs the capture control unit 1220 to stop capturing of images. Also, when the product information transmission request unit 1270 stops transmission of the product information display image 1101 to the display screen memory unit 341, the product information transmission request unit 1270 instructs the capture control unit 1220 to resume capturing images.

Flow of Search Process

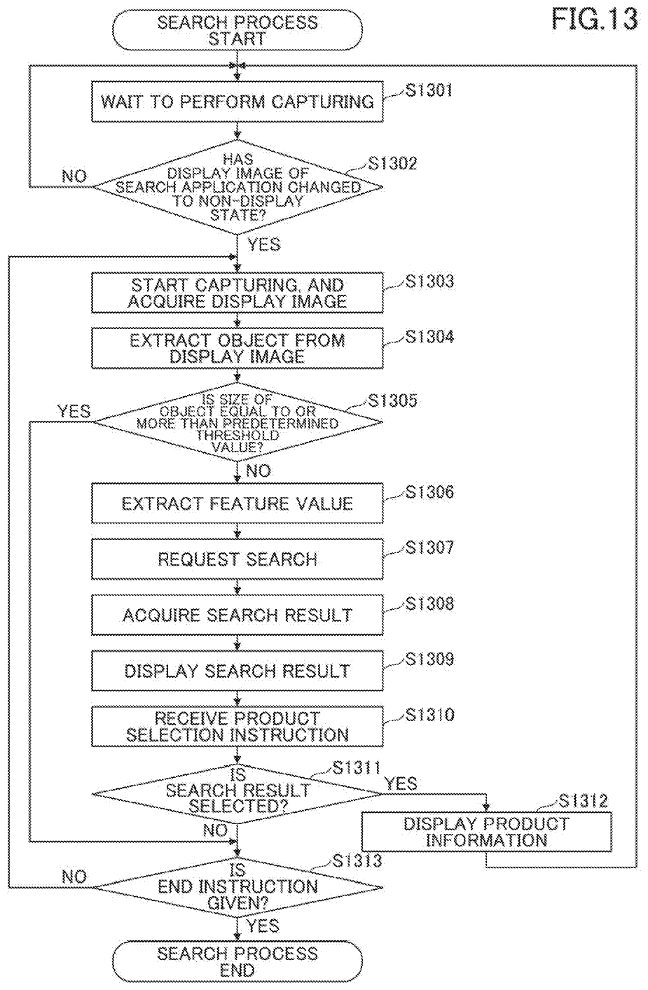

Subsequently, a flow of search process performed by the terminal apparatus 120 will be explained. FIG. 13 is a flowchart illustrating the flow of the search process performed by the terminal apparatus 120. When the search application 310 is started, the search method selection unit 1210 generates the selection screen image 611, and transmits the selection screen image 611 to the display screen memory unit 341, so that the selection screen image 611 is displayed on the display screen 600. Accordingly, the process illustrated in FIG. 13 is started.

In step S1301, the capture control unit 1220 waits until the capture control unit 1220 transmits a capture start instruction to the screen capture unit 342. Accordingly, the screen capture unit 342 waits in a stopped state without capturing the display image (i.e., in this case, the selection screen image 611) stored in the display screen memory unit 341. In step S1302, the capture control unit 1220 determines whether the display image (i.e., in this case, the selection screen image 611) of the search application 310 has disappeared. In step S1302, in a case where the capture control unit 1220 determines that the display image of the search application 310 is continued to be displayed (No in step S1302), the capture control unit 1220 returns back to step S1301.

In a case where the capture control unit 1220 determines that the display image of the search application 310 has disappeared in step S1302 (“Yes” in step S1302), the capture control unit 1220 proceeds to step S1303.

In step S1303, the capture control unit 1220 transmits a capture start instruction to the screen capture unit 342. Accordingly, the captured image acquisition unit 1230 starts a process to acquire a display image captured by the screen capture unit 342, at a predetermined cycle.

In step S1304, the object extraction unit 1240 extracts an image of an object from the acquired display image.

In step S1305, the object extraction unit 1240 determines whether the size of the image of the extracted object is equal to or more than a predetermined threshold value. In a case where the object extraction unit 1240 determines the size of the image of the extracted object is equal to or more than the predetermined threshold value in step S1305 (“Yes” in step S1305), the object extraction unit 1240 proceeds to step S1313.

In a case where the object extraction unit 1240 determines the size of the image of the extracted object is less than the predetermined threshold value in step S1305 (“No” in step S1305), the object extraction unit 1240 proceeds to step S1306.

In step S1306, the feature value calculation unit 1250 calculates a feature value in the image of the extracted object. It should be noted that, for example, the feature value calculation unit 1250 calculates a feature value by inputting training images of products to prepare a pre-trained model (neural network) for outputting product attribute information of a given product through machine learning and inputting the image of the extracted object to the prepared pre-trained model. In this case, the feature value calculation unit 1250 extracts the feature value as an n-dimensional vector from an intermediate layer of the pre-trained model.

In step S1307, the search request unit 1260 generates a search request including the calculated feature value, and transmits the search request to the communication device 306.

In step S1308, in a case where the search request unit 1260 receives the search result from the server apparatus 110 in response to the transmission of the search request by the communication device 306 to the server apparatus 110, the search request unit 1260 acquires the received search result. It should be noted that the server apparatus 110 searches for an image having a feature value similar to the feature value of the image included in the search request from among the images of the products stored in the product information storage unit 230, and transmits the search result to the communication device 306. The server apparatus 110 calculates, for example, a Euclidean distance between a feature value (n-dimensional vector) of the image included in the search request and a feature value (n-dimensional vector) of the image of a product stored in the product information storage unit 230. Then, the server apparatus 110 searches for an image of a product of which the calculated Euclidean distance satisfies a predetermined condition.

In step S1309, the search request unit 1260 transmits the acquired search result to the notification unit 343 of the OS 340. Accordingly, a message including the search result is notified to the user 150.

In step S1310, the search request unit 1260 receives a product selection instruction in response to a notification of a message including the search result to the user 150.

In step S1311, the product information transmission request unit 1270 determines whether the product selection instruction has been received or not. In a case where the product information transmission request unit 1270 determines that the product selection instruction has not been received in step S1311 (“No” in step S1311), the product information transmission request unit 1270 proceeds to step S1313.

In a case where the product information transmission request unit 1270 determines that the product selection instruction has been received in step S1311, (“Yes” in step S1311), the product information transmission request unit 1270 proceeds to step S1312.

In step S1312, the product information transmission request unit 1270 transmits, to the communication device 306, a product information transmission request for requesting the detailed information about the product (product information). As a result, the product information transmission request is transmitted to the server apparatus 110. The product information transmission request unit 1270 acquires, from the communication device 306, the product information transmitted from the server apparatus 110 in response to transmission of the product information transmission request. Further, the product information transmission request unit 1270 generates the product information display image 1101 on the basis of the acquired product information, and returns back to step S1301 after transmitting the generated product information display image 1101 to the display screen memory unit 341.

In this case, in step S1301, the capture control unit 1220 transmits a capture stop instruction to the screen capture unit 342. Accordingly, the screen capture unit 342 waits without capturing the display image stored in the display screen memory unit 341 (i.e., in this case, the product information display image 1101).

Also, in step S1302, the capture control unit 1220 determines whether the display image of the search application 310 (i.e., in this case, the product information display image 1101) has disappeared.

The capture control unit 1220 continues to transmit the capture stop instruction until the display image of the search application 310 is determined to have disappeared. When the capture control unit 1220 determines that the display image of the search application 310 has disappeared (i.e., the display image displayed on the display screen 500 has returned back to the SNS display image 821), the capture control unit 1220 transmits a capture start instruction to the screen capture unit 342 in step S1303.

Accordingly, the captured image acquisition unit 1230 resumes a process to acquire display images captured by the screen capture unit 342, at a predetermined cycle. Hereinafter, the process from step S1304 to step S1312 is similar to as described above.

In step S1313, the capture control unit 1220 determines whether the user 150 has entered an end instruction of the search application 310. In a case where the capture control unit 1220 determines that the user 150 has not entered the end instruction of the search application 310 in step S1313 (“No” in step S1313), the capture control unit 1220 returns back to step S1303. Conversely, in a case where the capture control unit 1220 determines that the user 150 has entered the end instruction of the search application 310 in step S1313 (“Yes” in step S1313), the capture control unit 1220 ends the search process. Specifically, after the capture control unit 1220 transmits a capture stop instruction to the screen capture unit 342, the capture control unit 1220 stops the search application 310 currently being executed.

Display Example of Search Result

Subsequently, a display example of the message 1011 including the search result 1001 will be explained. As described above, the message 1011 including the search result 1001 is displayed on the display screen 500 currently viewed by the user 150 while the SNS display image 821 is displayed, so that the message 1011 including the search result 1001 is notified to the user 150.

For this reason, the message 1011 is desired to be displayed at a position that does not interfere with browsing of the SNS display image 911.

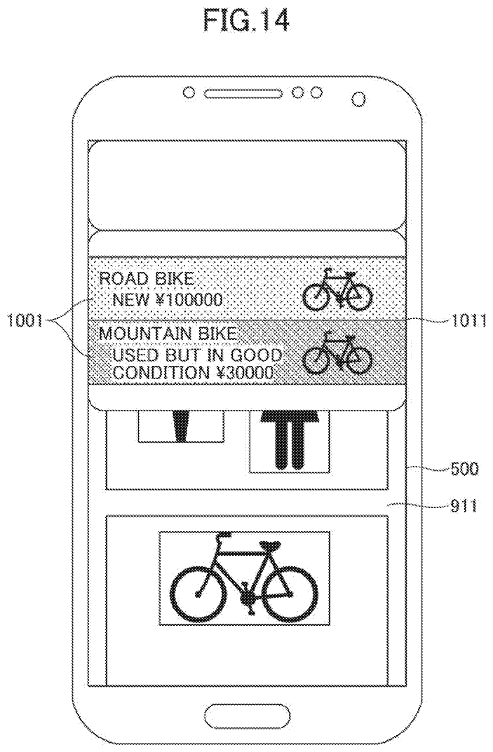

FIG. 14 is a display example of a message including a search result. In the case of FIG. 14, the message 1011 including the search result 1001 is displayed at an upper position of the display screen 500. In this way, since the message 1011 including the search result 1001 is displayed at the upper position of the display screen 500, the user 150 can see the search result 1001 while browsing an image of an object (a bicycle in the example of FIG. 14) extracted from the SNS display image 911.

In the example of FIG. 14, a message 1011 including multiple search result items (i.e., two search result items in the case of FIG. 14) is generated for the image of the single extracted object. Alternatively, the message 1011 may include only a single search result item.

Specifically, the message 1011 may include a single product having the highest similarity from among multiple products having feature values similar to the feature value calculated with respect to the image of the extracted object. Alternatively, products having the top N highest similarities (N is an integer of two or more) may be selected and included in the message 1011.

Alternatively, when the server apparatus 110 transmits a search result, a single product having the highest similarity may be selected as a single search result item, and the single search result item may be transmitted.

### SUMMARY

As is evident from the above explanation, the terminal apparatus according to the first embodiment is configured to receive an input of a start instruction for starting a search application before a start instruction for starting a predetermined application (e.g., a general-purpose application and a camera control application) is given. Accordingly, the search application transmits, to the screen capture unit of the operating system, a capture start instruction for capturing a display image displayed on the display screen.

The screen capture unit captures the display image generated by the predetermined application that is started after the search application is started, and the captured display image is acquired by the search application at a predetermined cycle.

The search application extracts an image of an object from the acquired display image, and transmits a search request with a feature value of the image of the extracted object as a search query.

The search application displays, on the display screen, a search result received from a server apparatus in response to transmission of the search request.

In this way, while the user is viewing the display image displayed on the display screen, the image of the object is automatically extracted from the display image displayed on the display screen, and the search request is transmitted.

Therefore, for example, the user does not have to explicitly perform an operation to capture an image of an object (with a screenshot and the like).

In addition, the user does not have to transmit a start request by newly starting a search application while the predetermined application is being executed.

As a result, according to the first embodiment, the operability of the search function using an image as a search query can be improved.

### Second Embodiment

The first embodiment has been explained based on the assumption that the message 1011 including the search result 1001 is notified to the user 150. However, the display method of the search result 1001 is not limited thereto. In the second embodiment, another display method for displaying a search result 1001 will be explained.

Display Example 1 of Search Result

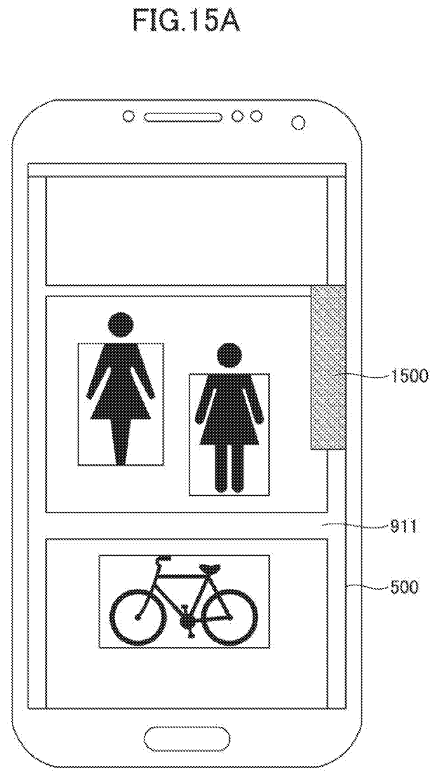

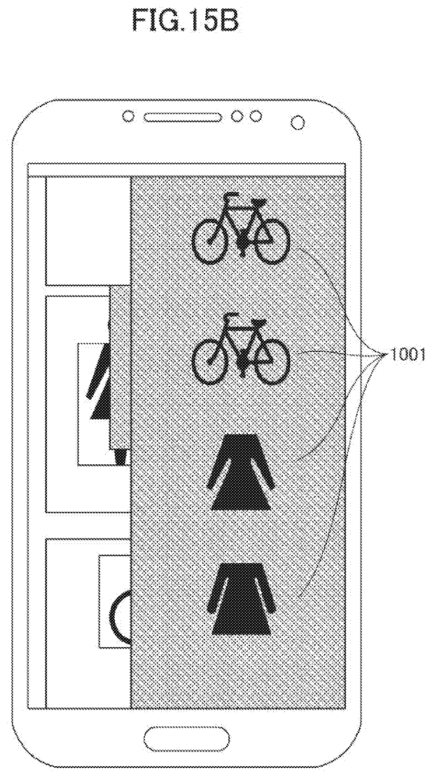

FIGS. 15A and 15B illustrate Display Example 1 of a search result. In the case of FIGS. 15A and 15B, the message 1011 including the search result 1001 is not displayed on the display screen 500, and only a tab 1500 is displayed on the display screen 500. FIG. 15A illustrates a state in which the tab 1500 is displayed at the right end of a display screen 500 while an SNS display image 911 is displayed on the display screen 500.

In this manner, only the tab 1500 is displayed at the right end of the display screen 500, which does not obstruct viewing of the SNS display image 911 by the user 150. FIG. 15B illustrates a state in which a search result 1001 is displayed after the user 150 swipes the tab 1500 displayed at the right end of the display screen 500 to the left-hand side. As illustrated in FIG. 15B, the search result 1001 is displayed as an image, but alternatively the search result 1001 may be displayed as text information.

In this manner, the search result 1001 is shown in accordance with a swipe operation of the user 150, so that the user 150 can see the search result for the image of the object extracted from the SNS display image 911 (i.e., bicycles and dresses in the example of FIG. 15B).

Note that the user 150 can hide the search result 1001 by swiping the tab 1500 to the right-hand side. In this manner, the user 150 can display the search result 1001 as needed, so that the user 150 can view the SNS display image 911 without being blocked by the displaying of the search result 1001.

Display Example 2 of Search Result

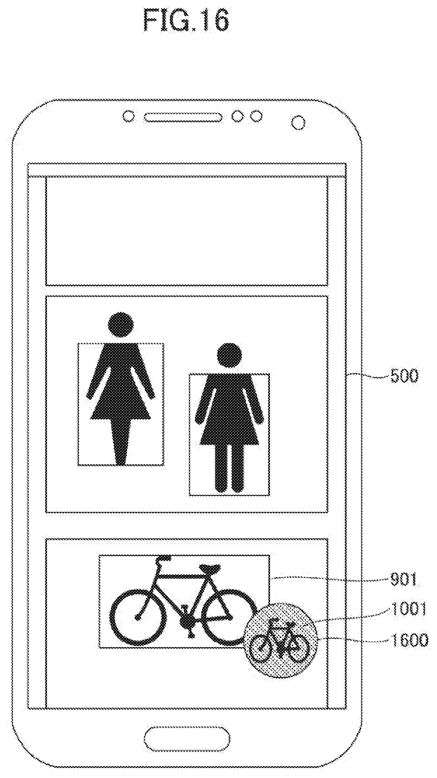

FIG. 16 is a drawing illustrating Display Example 2 of a search result. In the case of FIG. 16, a search result 1001 is displayed as a notification dot 1600 in association with a rectangular frame 901 of an object extracted from the SNS display image 911. In the example of FIG. 16, the search result 1001 is displayed as an image, but the search result 1001 may be displayed as text information.

In this manner, the notification dot 1600 is displayed in association with the rectangular frame 901 of the object, which does not obstruct viewing of the SNS display image 911 by the user 150. In addition, the user 150 can notice that a product similar to the image of the object extracted from the SNS display image 911, which the user 150 is currently viewing, has been found in the search.

### Third Embodiment

In each of the above embodiments, the feature value calculation unit 1250 and the search request unit 1260 are implemented on the terminal apparatus 120. Alternatively, the feature value calculation unit 1250 and the search request unit 1260 may be implemented on the server apparatus 110.

In this case, the terminal apparatus 120 extracts an image of an object from the display image given by the captured image acquisition unit 1230. Search requests including images of the extracted objects (search requests having images as search queries) are successively transmitted to the server apparatus 110.

Also, in each of the above embodiments, the search application is assumed to include the “search function”, the “information acquisition function”, and the “purchase function”, but the search application may further include a “setting function”.

For example, the search application 310 may be configured to allow the user 150 to set whether a rectangular frame circumscribing an extracted object is to be displayed on the display screen 500. Also, the search application 310 may be configured to allow the user 150 to set the number of search result items included in a message 1011. Also, the search application 310 may be configured to allow the user 150 to set a display method of a search result. Further, the search application 310 may be configured to allow the user 150 to set the size and the like of an object to be extracted.

In each of the above embodiments, a general-purpose application (for example, an SNS application) and a camera control application have been explained as examples of predetermined applications, but the predetermined applications are not limited thereto.

It is to be understood that the present invention is not limited to the configurations explained above. For example, the above embodiments may be combined with other elements. The configurations of the embodiments can be changed without departing from the gist of the present invention, and can be defined appropriately according to the form of the application.

What is claimed is:

1. A non-transitory computer-readable recording medium recorded with a search program executable by a processor of a terminal apparatus, the search program causing the processor to perform operations comprising:
issuing a capture start instruction to start to capture a display image displayed on a screen in response to a user operation;
acquiring the captured display image; and
issuing a search request including, as a search query, an image of an object extracted from the acquired display image, and displaying a search result on the screen.

2. The non-transitory computer-readable recording medium according to claim 1, wherein the processor is configured to issue the capture start instruction before a start instruction for starting a predetermined application is input, and
the processor is configured to acquire the display image generated while the predetermined application is being executed.

3. The non-transitory computer-readable recording medium according to claim 1, wherein the processor is configured to display an image for selecting a search method on the screen, and
the processor is configured not to display the search result on the screen while the image for selecting the search method is displayed on the screen.

4. The non-transitory computer-readable recording medium according to claim 1, wherein the processor is configured to, in a case where the search result is selected, display an image including detailed information about the search result, and
the processor is configured not to display the search result on the screen while the image including the detailed information about the search result is displayed on the screen.

5. The non-transitory computer-readable recording medium according to claim 1, wherein the processor is configured not to display the search result on the screen in a case where a size of the image of the object extracted from the acquired display image is a predetermined threshold value or more.

6. The non-transitory computer-readable recording medium according to claim 1, wherein the capture start instruction is given to an Operating System to perform the capturing of the display image.

7. The non-transitory computer-readable recording medium according to claim 1, wherein in response to issuing of the search request, a site providing a service for buying and selling a product is searched.

8. A search method comprising:
issuing a capture start instruction to start to capture a display image displayed on a screen in response to a user operation;
acquiring the captured display image; and
issuing a search request including, as a search query, an image of an object extracted from the acquired display image, and displaying a search result on the screen.

9. A terminal apparatus comprising:
a memory; and
a processor coupled to the memory and configured to perform operations comprising:
issuing a capture start instruction to start to capture a display image displayed on a screen in response to a user operation;
acquiring the captured display image; and
issuing a search request including, as a search query, an image of an object extracted from the acquired display image, and displaying a search result on the screen.
